(19) United States
(12) Patent Application Publication
(10) Pub. No.: US 2021/0321437 A1
(43) Pub. Date: Oct. 14, 2021

(54) METHOD, APPARATUS AND COMPUTER PROGRAM PRODUCT

(71) Applicant: Nokia Technologies Oy, Espoo (FI)

(72) Inventors: Jianguo LIU, Shanghai (CN); Tao TAO, Shanghai (CN); Zhe LUO, Shanghai (CN); Yan MENG, Shanghai (CN); Gang SHEN, Shanghai (CN); Claudio ROSA, Randers NV (DK)

(21) Appl. No.: 17/270,270

(22) PCT Filed: Sep. 28, 2018
(86) PCT No.: PCT/CN2018/108460

§ 371 Date: Feb. 22, 2021

(51) Int. Cl. H04W 72/12; H04W 76/28

(52) U.S. Cl. CPC H04W 72/1273; H04W 76/28

(57) ABSTRACT

There is provided a method comprising: receiving from a second cell at a user equipment in a first state of discontinuous reception mode for a first cell, an indication configured to cause the user equipment to operate in a second state of discontinuous reception mode for the first cell; and receiving, at the user equipment from the first cell, data, said data being scheduled based on the indication.

### TECHNICAL FIELD

Some embodiments relate to a method, apparatus, computer program product and system for controlling a discontinuous reception state of a user equipment.

### BACKGROUND

In long term evolution (LTE) and new radio (NR), discontinuous reception (DRX) were introduced so as to make trade-off between user equipment (UE) power consumption and reachability. For DRX operation, a UE is configured with a set of DRX parameters to monitor a physical downlink control channel (PDCCH) during a DRX active time. The DRX configuration controls the active time in a cycle when the UE should monitor the PDCCH to determine if it is being scheduled by the cell. For licensed access, the trade-off between reachability and UE power consumption may be controlled by the network through timers such as onDurationTimer, drx-InactivityTimer and drx-RetransmissionTimer.

In carrier aggregation (CA), a common DRX configuration per medium access control (MAC) entity may be applied in both LTE and NR so that the MAC entity is provided with similar scheduling opportunity for each cell. That is to say the DRX enabled UE needs to monitor PDCCH on all activated serving cells in the DRX active time. In case of dual connectivity (DC), the UE may be configured with two MAC entities: one MAC entity for a master eNodeB (MeNB) and one MAC entity for a secondary eNodeB (SeNB).

Furthermore, unlicensed technologies may need to abide to the conformance requirement of regulations such as Listen-Before-Talk (LBT) regulation so as to ensure existence fairness with other devices in the shared unlicensed spectrum. This may mean that, prior to transmission, the transmitter side may perform LBT operation on the unlicensed spectrum. For example, the eNB or gNB shall sense the channel for downlink transmission and can start transmission only if the channel is at the idle status.

### SUMMARY

According to an aspect, there is provided a method comprising receiving from a second cell at a user equipment in a first state of discontinuous reception mode for a first cell, an indication configured to cause the user equipment to operate in a second state of discontinuous reception mode for the first cell; and receiving, at the user equipment from the first cell, data, said data being scheduled based on the indication.

The indication may be received when the user equipment is in a DRX active state for the first cell.

The indication may be received when the user equipment is in a DRX inactive state for the first cell.

The first discontinuous reception state for the first cell may be the same as a discontinuous reception state for the second cell.

The first discontinuous reception state for the first cell may be different to a discontinuous reception state for the second cell.

The first cell may operate on an unlicensed frequency spectrum.

The second cell may operate on one of a licensed frequency spectrum and an unlicensed frequency spectrum.

The first cell and the second cell may be comprised within the same cell group.

The first cell and the second cell may be comprised within different cell groups.

The second cell may be selected from one or more secondary cells.

At least one of the one or more secondary cells may operate on at least one of a licensed frequency spectrum; and an unlicensed frequency spectrum.

The selected second cell may comprise a one of the one or more secondary cells that complete a listen-before-talk procedure.

The method may comprise transmitting, from the user equipment to the second cell, one of an acknowledgement and a negative acknowledgement, in response to receiving the indication.

The method may comprise initiating, by the user equipment, at least one of a drx-InactivityTimer; and a drx-RetransmissionTimer.

The indication may be configured to cause the user equipment to initiate an additional active discontinuous reception period, wherein the user equipment is able to receive a transmission from the network during the additional active discontinuous reception period.

The additional active discontinuous reception period may be based, at least in part, on the indication.

The method may comprise receiving, at the user equipment from one of the first cell and the second cell, signalling comprising a first time period and a starting time for the first time period.

The indication may comprise a first time period and a starting time for the first time period.

The first time period may define a duration of the additional active discontinuous reception period.

The starting time for the first time period may define a starting time for the additional active discontinuous reception period with respect to the indication.

The indication may be configured to cause the user equipment to operate in an extended discontinuous reception mode.

The extended discontinuous reception period may be extended with respect to a discontinuous reception period of a normal discontinuous reception mode.

The method may comprise receiving, at the user equipment from one of the first cell and the second cell, signalling comprising a configuration of the extended discontinuous reception mode.

The indication may be configured to cause the user equipment to start a second timer.

The second timer may define a time period after which the user equipment switches from the extended discontinuous reception mode to a normal discontinuous reception mode.

The method may comprise receiving, at the user equipment from at least one of the first cell and the second cell, deactivation signalling.

The deactivation signalling may be configured to cause the user equipment to switch from the extended discontinuous reception mode to a normal discontinuous reception mode.

A duration of the active discontinuous reception period of the normal discontinuous reception mode may be shorter than the duration of the active discontinuous reception period of the extended discontinuous reception mode.

According to an aspect, there is provided an apparatus comprising means for: receiving from a second cell at a user equipment in a first state of discontinuous reception mode for a first cell, an indication configured to cause the user equipment to operate in a second state of discontinuous reception mode for the first cell; and receiving, at the user equipment from the first cell, data, said data being scheduled based on the indication.

The indication may be received when the user equipment is in a DRX active state for the first cell.

The indication may be received when the user equipment is in a DRX inactive state for the first cell.

The first discontinuous reception state for the first cell may be the same as a discontinuous reception state for the second cell.

The first discontinuous reception state for the first cell may be different to a discontinuous reception state for the second cell.

The first cell may operate on an unlicensed frequency spectrum.

The second cell may operate on one of a licensed frequency spectrum and an unlicensed frequency spectrum.

The first cell and the second cell may be comprised within the same cell group.

The first cell and the second cell may be comprised within different cell groups.

The second cell may be selected from one or more secondary cells.

At least one of the one or more secondary cells may operate on at least one of a licensed frequency spectrum; and an unlicensed frequency spectrum.

The selected second cell may comprise a one of the one or more secondary cells that complete a listen-before-talk procedure.

The apparatus may comprise means for transmitting, from the user equipment to the second cell, one of an acknowledgement and a negative acknowledgement, in response to receiving the indication.

The apparatus may comprise means for initiating, by the user equipment, at least one of a drx-InactivityTimer; and a drx-RetransmissionTimer.

The indication may be configured to cause the user equipment to initiate an additional active discontinuous reception period, wherein the user equipment is able to receive a transmission from the network during the additional active discontinuous reception period.

The additional active discontinuous reception period may be based, at least in part, on the indication.

The apparatus may comprise means for receiving, at the user equipment from one of the first cell and the second cell, signalling comprising a first time period and a starting time for the first time period.

The indication may comprise a first time period and a starting time for the first time period.

The first time period may define a duration of the additional active discontinuous reception period.

The starting time for the first time period may define a starting time for the additional active discontinuous reception period with respect to the indication.

The indication may be configured to cause the user equipment to operate in an extended discontinuous reception mode.

The extended discontinuous reception period may be extended with respect to a discontinuous reception period of a normal discontinuous reception mode.

The apparatus may comprise means for receiving, at the user equipment from one of the first cell and the second cell, signalling comprising a configuration of the extended discontinuous reception mode.

The indication may be configured to cause the user equipment to start a second timer.

The second timer may define a time period after which the user equipment switches from the extended discontinuous reception mode to a normal discontinuous reception mode.

The apparatus may comprise means for receiving, at the user equipment from at least one of the first cell and the second cell, deactivation signalling.

The deactivation signalling may be configured to cause the user equipment to switch from the extended discontinuous reception mode to a normal discontinuous reception mode.

A duration of the active discontinuous reception period of the normal discontinuous reception mode may be shorter than the duration of the active discontinuous reception period of the extended discontinuous reception mode.

According to an aspect, there is provided an apparatus comprising at least one memory and at least one processor, the at least one memory storing computer executable instructions which, when performed by the at least one processor, cause the apparatus to: receive, from a second cell at a user equipment in a first state of discontinuous reception mode for a first cell, an indication configured to cause the user equipment to operate in a second state of discontinuous reception mode for the first cell; and receive, at the user equipment from the first cell, data, said data being scheduled based on the indication.

The at least one processor may be configured to cause the apparatus to perform any of the method described above.

According to an aspect, there is provided a computer program product comprising computer executable instructions which, when performed by at least one processor, cause an apparatus to: receive, from a second cell at a user equipment in a first state of discontinuous reception mode for a first cell, an indication configured to cause the user equipment to operate in a second state of discontinuous reception mode for the first cell; and receive, at the user equipment from the first cell, data, said data being scheduled based on the indication.

The computer program product may comprise computer executable instructions which, when performed by the at least one processor, cause the apparatus to perform any of the method described above.

According to an aspect, there is provided a method comprising: selecting, by a first cell, one or more second cells for transmitting an indication to a user equipment, said user equipment having a first state of discontinuous reception mode for the first cell, said indication configured to cause the user equipment to operate in a second state of discontinuous reception mode for the first cell; and transmitting, by the first cell to the user equipment, data, said data being scheduled based on the indication.

According to an aspect, there is provided a method comprising: transmitting, by a first network control node to a second network control node, a request for transmission of an indication to a user equipment, said user equipment having a first state of discontinuous reception mode for the first cell, said indication configured to cause the user equipment to operate in a second state of discontinuous reception mode for the first cell; and transmitting, by the first cell to the user equipment, data, said data being scheduled based on the indication.

According to an aspect, there is provided a method comprising: selecting, by a second cell, one or more second cells for transmitting an indication to a user equipment, said user equipment having a first state of discontinuous reception mode for the first cell, said indication configured to cause the user equipment to operate in a second state of discontinuous reception mode for the first cell; and transmitting, by the second cell to the user equipment, the indication.

According to an aspect, there is provided a method comprising: receiving, at a second network control node from a first network control node, a request for transmission of an indication to a user equipment, said user equipment having a first state of discontinuous reception mode for the first cell, said indication configured to cause the user equipment to operate in a second state of discontinuous reception mode for the first cell; selecting, by the second network control node, one second cell from among one or more secondary cells for transmitting the indication to the user equipment; and transmitting, by the selected second cell to the user equipment, the indication.

According to an aspect, there is provided an apparatus comprising means for: selecting, by a first cell, one or more second cells for transmitting an indication to a user equipment, said user equipment having a first state of discontinuous reception mode for the first cell, said indication configured to cause the user equipment to operate in a second state of discontinuous reception mode for the first cell; and transmitting, by the first cell to the user equipment, data, said data being scheduled based on the indication.

According to an aspect, there is provided an apparatus comprising means for: transmitting, by a first network control node to a second network control node, a request for transmission of an indication to a user equipment, said user equipment having a first state of discontinuous reception mode for the first cell, said indication configured to cause the user equipment to operate in a second state of discontinuous reception mode for the first cell; and transmitting, by the first cell to the user equipment, data, said data being scheduled based on the indication.

According to an aspect, there is provided an apparatus comprising means for: selecting, by a second cell, one or more second cells for transmitting an indication to a user equipment, said user equipment having a first state of discontinuous reception mode for the first cell, said indication configured to cause the user equipment to operate in a second state of discontinuous reception mode for the first cell; and transmitting, by the second cell to the user equipment, the indication.

According to an aspect, there is provided an apparatus comprising means for: receiving, at a second network control node from a first network control node, a request for transmission of an indication to a user equipment, said user equipment having a first state of discontinuous reception mode for the first cell, said indication configured to cause the user equipment to operate in a second state of discontinuous reception mode for the first cell; selecting, by the second network control node, one second cell from among one or more secondary cells for transmitting the indication to the user equipment; and transmitting, by the selected second cell to the user equipment, the indication.

According to an aspect, there is provided an apparatus comprising at least one memory and at least one processor, the at least one memory storing computer executable instructions which, when performed by the at least one processor, cause the apparatus to: select, by a first cell, one or more second cells for transmitting an indication to a user equipment, said user equipment having a first state of discontinuous reception mode for the first cell, said indication configured to cause the user equipment to operate in a second state of discontinuous reception mode for the first cell; and transmit, by the first cell to the user equipment, data, said data being scheduled based on the indication.

According to an aspect, there is provided an apparatus comprising at least one memory and at least one processor, the at least one memory storing computer executable instructions which, when performed by the at least one processor, cause the apparatus to: transmit, by a first network control node to a second network control node, a request for transmission of an indication to a user equipment, said user equipment having a first state of discontinuous reception mode for the first cell, said indication configured to cause the user equipment to operate in a second state of discontinuous reception mode for the first cell; and transmit, by the first cell to the user equipment, data, said data being scheduled based on the indication.

According to an aspect, there is provided an apparatus comprising at least one memory and at least one processor, the at least one memory storing computer executable instructions which, when performed by the at least one processor, cause the apparatus to: select, by a second cell, one or more second cells for transmitting an indication to a user equipment, said user equipment having a first state of discontinuous reception mode for the first cell, said indication configured to cause the user equipment to operate in a second state of discontinuous reception mode for the first cell; and transmit, by the second cell to the user equipment, the indication.

According to an aspect, there is provided an apparatus comprising at least one memory and at least one processor, the at least one memory storing computer executable instructions which, when performed by the at least one processor, cause the apparatus to: receive, at a second network control node from a first network control node, a request for transmission of an indication to a user equipment, said user equipment having a first state of discontinuous reception mode for the first cell, said indication configured to cause the user equipment to operate in a second state of discontinuous reception mode for the first cell; select, by the second network control node, one second cell from among one or more secondary cells for transmitting the indication to the user equipment; and transmit, by the selected second cell to the user equipment, the indication.

According to an aspect, there is provided a computer program product comprising computer executable instructions which, when performed by at least one processor, cause an apparatus to: select, by a first cell, one or more second cells for transmitting an indication to a user equipment, said user equipment having a first state of discontinuous reception mode for the first cell, said indication configured to cause the user equipment to operate in a second state of discontinuous reception mode for the first cell; and transmit, by the first cell to the user equipment, data, said data being scheduled based on the indication.

According to an aspect, there is provided a computer program product comprising computer executable instructions which, when performed by at least one processor, cause an apparatus to: transmit, by a first network control node to a second network control node, a request for transmission of an indication to a user equipment, said user equipment having a first state of discontinuous reception mode for the first cell, said indication configured to cause the user equipment to operate in a second state of discontinuous reception mode for the first cell; and transmit, by the first cell to the user equipment, data, said data being scheduled based on the indication.

According to an aspect, there is provided a computer program product comprising computer executable instructions which, when performed by at least one processor, cause an apparatus to: select, by a second cell, one or more second cells for transmitting an indication to a user equipment, said user equipment having a first state of discontinuous reception mode for the first cell, said indication configured to cause the user equipment to operate in a second state of discontinuous reception mode for the first cell; and transmit, by the second cell to the user equipment, the indication.

According to an aspect, there is provided a computer program product comprising computer executable instructions which, when performed by at least one processor, cause an apparatus to: receive, at a second network control node from a first network control node, a request for transmission of an indication to a user equipment, said user equipment having a first state of discontinuous reception mode for the first cell, said indication configured to cause the user equipment to operate in a second state of discontinuous reception mode for the first cell; select, by the second network control node, one second cell from among one or more secondary cells for transmitting the indication to the user equipment; and transmit, by the selected second cell to the user equipment, the indication.

### BRIEF DESCRIPTION OF THE DRAWINGS

FIG. 1 shows a schematic example of a wireless communication system;

FIG. 2 shows an example of a communication device;

FIG. 3 shows an example of control apparatus;

FIG. 4 shows an example of a listen-before-talk and DRX configuration;

FIG. 5 shows an example of a listen-before-talk and modified DRX configuration according to some embodiments;

FIG. 6 shows an example of a listen-before-talk and modified DRX configuration according to some embodiments;

FIGS. 7 to 9 show examples of signalling exchanges according to some embodiments;

FIG. 10 shows an apparatus according to some embodiments; and

FIG. 11 shows a representation of a non-volatile memory medium storing instructions which when executed by a processor allow the processor to perform one or more of the method steps according to some embodiments.

### DETAILED DESCRIPTION

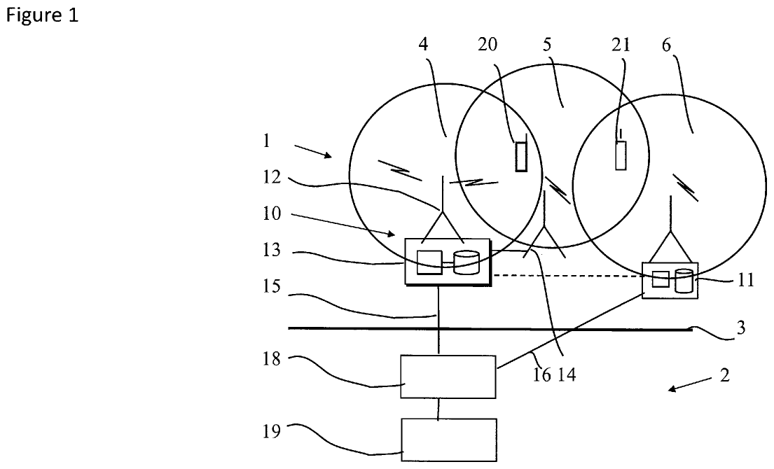

In the following certain exemplifying embodiments are explained with reference to a wireless communication system serving communication devices adapted for wireless communication. Certain general principles of wireless systems are first briefly explained with reference to FIGS. 1 to 3.

A communication device 20, 21 can be used for accessing various services and/or applications provided via cells 4, 5, 6 of a cellular system. In a wireless communication system the access can be provided via wireless access interfaces between wireless communication devices and one or more base stations of a radio access network 1. Each mobile device and base station may have one or more radio channels open at the same time and may receive signals from more than one source.

A base station site can provide at least one cell. In the highly schematic FIG. 1 example, a base station site 10 comprising a controller 13 and base station apparatus 12 and 14 is shown to provide a plurality of cells 4 and 5, respectively. In the example of FIG. 1 cell 4 is provided by antenna apparatus of station 12 in one location, and at least one further cell is provided by a remote radio head 14. It is noted that this exemplifying arrangement is only shown for illustrative purposes, and that e.g. antenna apparatus 12 can provide more than one cell. The relevance in view of certain examples described below is that the controller 13 of the base station site 10 can control access and devices accessing the radio access network 1 in a number of cells.

In addition to the base station site 12, at least one other cell can also be provided by means of another base station or stations. This possibility is denoted by base station 11 in FIG. 1. Signalling between base stations, and controllers thereof, can be provided via an appropriate interface, for example an X2 interface or an evolution of X2 interface which may be referred to as Xn interface. The Xn interface may be used in 5G, and may comprise enhancements over the X2 interface. This is denoted by the dashed line between the control entities 13 and 11.

A wireless system is typically divided between a radio access system 1, typically called radio access network (RAN) and a core network (CN) 2. The division is denoted by line 3. The core network can comprise elements such as mobile management entity (MME) 18, home subscriber server (HSS) 19 and so forth. Connection between base station sites of the radio access network (RAN) and core network (CN) element can be provided via appropriate interfaces 15, 16. The connection between the RAN and the CN can be, for example, via a S1 interface or an evolution of the S1 interface which may be referred to as S1* interface. The S1* interface may be used in 5G, and may comprise enhancements over the S1 interface.

A communication device can access a communication system based on various access techniques, for example those based on the third Generation Partnership Project (3GPP) specifications. A non-limiting example of mobile architectures is known as the Evolved Universal Terrestrial Radio Access Network (E-UTRAN). The architecture may of course alternatively comprise a future equivalent to E-UTRAN, for example the architecture of the New Radio or 5G network. A non-limiting example of a base station of a cellular system is what is termed as a NodeB or E-UTRAN NodeB (eNB/ENodeB) in the vocabulary of the 3GPP specifications. The eNBs may provide E-UTRAN features such as user plane Radio Link Control/Medium Access Control/Physical Layer Protocol (RLC/MAC/PHY) and control plane Radio Resource Control (RRC) protocol terminations towards mobile communication devices. At least some of the stations may be arranged to operate on the unlicensed radio spectrum. In the parlance of 5G these base stations may be referred to as gNBs or next generation Node Bs.

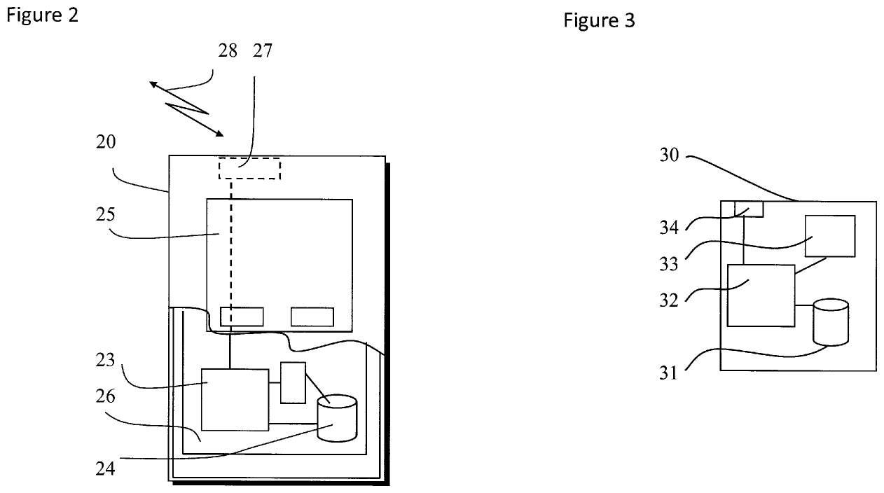

FIG. 2 shows a schematic, partially sectioned view of a communication device 20 that a user can use for communications. Such a communication device is often referred to as user equipment (UE) or terminal. An appropriate communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia, positioning data, other data, and so on. Users may thus be offered and provided numerous services via their communication devices. Non-limiting examples of these services include two-way or multi-way calls, data communication or multimedia services or simply an access to a data communications network system, such as the Internet.

A mobile device is typically provided with at least one data processing entity 23, at least one memory 24 and other possible components 29 for use in software and hardware aided execution of tasks it is designed to perform, including control of access to and communications with base stations and/or other user terminals. The tasks can include operation related to mobility management such as handling handovers and cell reselections. Further, the tasks can also relate to security aspects of the communications. The data processing, storage and other relevant control apparatus can be provided on an appropriate circuit board and/or in chipsets. This apparatus is denoted by reference 26.

A user may control the operation of the device 20 by means of a suitable user interface such as key pad, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

The device 20 may receive and transmit signals 28 via appropriate apparatus for receiving and transmitting signals. In FIG. 2 transceiver apparatus is designated schematically by block 27. The transceiver may be provided for example by means of a radio part and associated antenna arrangement. The antenna arrangement may be arranged internally or externally to the mobile device. A wireless communication device can be provided with a Multiple Input/Multiple Output (MIMO) antenna system.

FIG. 3 shows an example of a control apparatus 30 for a station, for example to be coupled to and/or for controlling one of the stations 11, 12 and 14 of FIG. 1. The control apparatus 30 can be arranged to provide control on configurations used by the communications devices accessing the station, information processing and/or communication operations. A control apparatus can be configured to provide control functions in association with generation, communications, and interpretation of control information. The control apparatus 30 comprises at least one memory 31, at least one data processing unit 32, 33 and an input/output interface 34. Via the interface the control apparatus can be coupled to the relevant node. The control apparatus 30 can be configured to execute an appropriate software code to provide the control functions.

A user equipment may operate in a power saving mode. In some embodiments, this power saving mode may be a discontinuous reception (DRX) mode. In DRX, the UE may receive discontinuous reception (DRX) cycle related parameters from system information broadcast message as part of the system information broadcast. Alternatively or additionally, the DRX parameters may be predefined.

In DRX mode, a user equipment may operate in a DRX active, or high power mode, and a DRX inactive, or low power mode. In the DRX inactive mode, a first receiver, for communicating over a first cell may be turned off. In the DRX active mode, the first receiver, for communicating over the first cell, may be turned on.

When operating in DRX mode, the UE periodically wakes up to monitor the physical downlink control channel (PDCCH) in order to check for the presence of a paging message encrypted by paging radio network temporary identifier (P-RNTI). If the PDCCH indicates that a paging message is transmitted in the subframe, then the UE demodulates the physical channel (PCH) to see if the paging message is directed to it. Paging messages are typically sent by a mobility management entity (MME) to all eNBs in a Tracking Area, and those eNBs in a Tracking Area transmit the same paging message. A similar DRX has been considered for 5G/N-RAT.

Furthermore, a user equipment may operate within an unlicensed cell. An unlicensed cell may need to undergo Listen-Before-Talk or Listen-Before-Transmit (LBT) regulation to minimise the chance of interference with other devices sharing the unlicensed spectrum. In some cases, a successful LBT process may be required before each transmission.

Thus in some situations of unlicensed frequency spectrum access, there may be no certainty that a user equipment can receive data from a network even when the user equipment is monitoring the PDCCH. Failure by the network to acquire a particular communication channel may result in an increase in scheduling latency. For example, if downlink data arrives at the user equipment while the user equipment is in DRX inactive state, and the network is unable to acquire the channel during a DRX active state, the network may have to wait at least another full DRX cycle before being able to transmit the downlink data to the user equipment.

The term “channel”, “communication channel”, or “frequency channel” as used herein is defined as a frequency channel over which data may be transmitted. A frequency channel may comprise part of a frequency spectrum. The spectrum may be an unlicensed frequency spectrum or a licensed frequency spectrum. In some non-limiting examples, the channel bandwidth may be 5 MHz, 20 MHz or 40 MHz.

In an embodiment, the term “cell” refers to a frequency channel provided by a network node, meaning that a wireless communication may be transmitted on the frequency channel within a wireless network which is controlled by the network node. A first cell may comprise a first frequency channel provided by a first network node. A second cell may comprise a second frequency channel. The second frequency channel may be provided by the first network node, or alternatively may be provided by a second network node. A cell may be configured to operate using a licensed frequency spectrum (a licensed cell) or may be configured to operate using an unlicensed frequency spectrum (an unlicensed cell).

In an embodiment, the term “cell” may, additionally or alternatively, be defined as a geographical area covered by a wireless transmitter, e.g. the network node. The geographical area may be covered by means of transmissions over a frequency channel. A first cell may be provided by a first network node. A second cell may be provided by the first network node, or alternatively may be provided by a second network node. The first cell and the second cell may be overlapping. Transmissions over the first cell and over the second cell may be performed over the same frequency channel, or over different frequency channels.

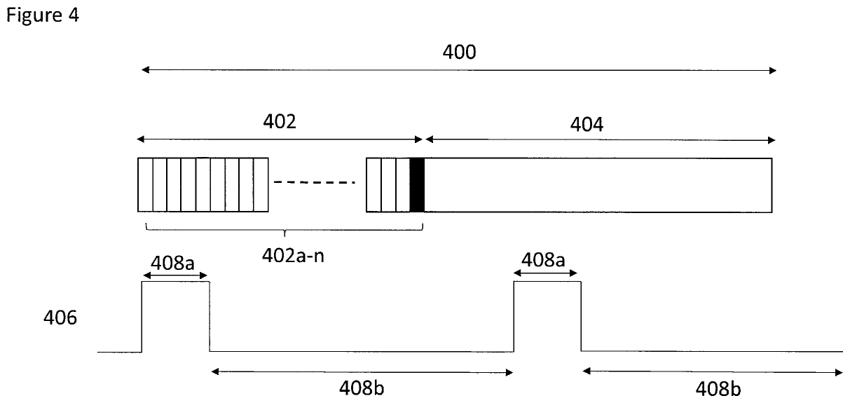

This is shown conceptually in FIG. 4. A network node may undertake a LBT procedure, where the access node monitors a communication channel to determine whether the communication channel is idle or occupied, and whether the communication channel can be accessed. A LBT period 400 may be divided up into a listening period 402 and a talking period 404. During the listening period 402, the network node may monitor a communication channel for communications. During the talking period 404, the network node may transmit data to a user equipment via the communication channel. The listening period 402 may be divided into a plurality of transmission blocks 402a-n.

The DRX configuration of the user equipment 406 shows a DRX cycle 408. The DRX cycle may comprising a DRX active state 408a, during which the user equipment is able to receive data, and a DRX inactive state 408b, during which the user equipment is unable to receive data.

If the DRX active state 408a corresponds to the listening period 402, the network node may be unable to send data to the user equipment. Consequently, the network may have to wait until a subsequent DRX cycle where the DRX active state of the user equipment corresponds to the talking period 404 to transmit data.

In some embodiments, a network may transmit at least one PDCCH to a user equipment in a first cell. A DRX state of the user equipment may be controlled based on activation signalling from the network via one or more other cells. In some embodiments, the activation signalling comprises a wake-up period. The activation signalling may cause the user equipment to alter the DRX state of the user equipment.

In some embodiments, the network may determine whether a trigger condition is met. Determining the trigger condition may comprise determining that data to be transmitted to a user equipment via a first cell can be delivered. This may comprise the network determining whether the user equipment is in a DRX active state for long enough to receive the data from the first cell. In some embodiments, the network may use any suitable trigger condition to determine whether the DRX state of the user equipment needs altering in order to receive the data to be transmitted.

In some embodiments, the network may send the activation signalling to the user equipment. The activation signalling may cause the user equipment to start a wake-up period. The wake-up period may comprise an additional DRX active period for the user equipment to monitor PDCCH in the first cell.

In some embodiments the activation signalling may be sent from the network to the user equipment via one or more other cells. There may be a default value for the duration of the wake-up period. Additionally or alternatively, the duration of the wake-up period may be specified by the activation signalling.

The network nodes, or cells controlled by the network nodes, may be arranged into one or more groups. A group may comprise one or more network nodes managed by a same network control node. A network control node may be implemented as part of at least one network node. Additionally or alternatively, a network control node may be implemented as a separate control node. The network control node may control one or more network nodes, such as but not limited to base stations or access nodes. Thus a same network node may be comprised in more than one group. A network node may operate using one or more frequency channels and/or cells.

The activation signalling may be sent via one or more cells in a local cell group and/or a second cell group. The one or more cells may be selected based on the network configuration. The one or more other cells may comprise a licensed cell. The one or more other cells may comprise a group of unlicensed cells.

Where the activation signalling is transmitted from a second cell group, a network control node of the local cell group may send a request to a network control node of the second cell group to cause transmission of the activation signalling. Once the activation signalling has been sent from the second cell group, the network control node of the second cell group may send an indication to the network control node of the first cell group. The indication may comprise the transmission time of the activation signalling. The indication may enable the network control node of the local cell group to synchronize the timing of the wake-up-period with the user equipment.

The activation signalling may comprise an index indicating to the user equipment what group PDCCH the user equipment is to monitor during the DRX active state.

In some embodiments, the network control node of the local cell group may select the one or more other cells from among the local cell group and/or the second cell group. The one or more other cells may be selected based on at least one metric. The at least one metric may comprise any suitable metric, such as but not limited to a transmission availability of a respective cell. In some embodiments, a licensed cell may be preferentially selected as one or the one or more other cells. In some embodiments, at least one unlicensed cell may be selected as one of the one or more other cells.

The activation signalling may be indicated via layer 1 (i.e. a physical layer) downlink control information.

In some embodiments, the user equipment may be configured to transmit an acknowledgement (ACK) and/or negative acknowledgement (NACK) in response to receiving the activation signalling. In some embodiments, the ACK/NACK may be transmitted to the one or more other cells from which the user equipment received the activation signalling.

In some embodiments, the user equipment may be configured to receive the activation signalling from the one or more other cells. In response, the user equipment may be configured to start a wake-up period.

The wake-up period may be started after a particular number of wake-up period slots, n_{WUT}. The value of n_{WUT} may be controlled by the activation signalling and/or other RRC signalling. Additionally or alternatively, the value of n_{WUT} may be a predetermined value. In some embodiments, n_{WUT} may determine a certain time duration (i.e. a time offset) for the start of the wake-up period with respect to the reception of the activation signalling. The value of n_{WUT} may be determined to account for latency in signalling detection and/or exchange between the network control node of the local cell group and the network control node of the second cell group.

In some embodiments, having transmitted the activation signalling to the user equipment, the network node of the local cell group may transmit the pending data to the user equipment during the duration of the wake-up period via the local cell group.

In some embodiments, the user equipment may receive the data via the local cell group. The user equipment may then decode the received data. If the user equipment successfully receives and decodes a PDCCH transmission within the duration of the wake-up period, the user equipment may start an inactivity or retransmission timer. Otherwise, the user equipment may re-enter DRX inactive status.

Some embodiments may be applied where a DRX enabled user equipment is served by a local cell group comprising multiple cells that are aggregated in order to provide an improved data rate for user equipments, such as a carrier aggregation deployment. Additionally or alternatively, the user equipment may be enabled to exchange data between itself and a network node of the local cell group, as well as simultaneously with a network node of the second cell group, when the user equipment is operating in dual connectivity mode.

In such an example, the network node of the local cell group may be termed a “Master Node”, the local cell group termed a “Master Cell Group”, the network node of the second cell group termed a “Secondary Node”, and the second cell group termed a “Secondary Cell Group”.

In some embodiments, the local/second network nodes may comprise any suitable network node. For example, the network node may comprise an LTE base station (i.e. an eNB), a NR base station (i.e. a gNB), or a hybrid base station (i.e. a ng-eNB). The local/second cell groups may comprise any combination of unlicensed cells and/or licensed cells.

In some embodiments, the network may cause the transmission of the activation signalling based on a trigger condition. The trigger condition may comprise any suitable condition, such as but not limited to:

a data traffic type;

a quality of service of a scheduled transmission;

a number of failed LBT transmission attempts; and

a buffer depth of traffic in the first cell for the user equipment reaching a given level.

In some embodiments, the network may configure the one or more other cells in the local cell group and/or the secondary cell group to extend the DRX active duration based on a channel access uncertainty in the unlicensed spectrum. In some embodiments the user equipment may have a different DRX state per cell group. The network may switch the user equipment to DRX active mode in the secondary cell group while retaining a DRX inactive state in the local cell group.

In some embodiments, the activation signalling may comprise at least one of the following:

an activation flag;

a duration of the wake-up period;

a starting time of the wake-up period;

a cell group flag; and

other configurable information.

The activation flag may be used to activate the wake-up period at the user equipment. The activation may be implicitly indicated by the detection of dedicated downlink control information or a medium access control element. Alternatively, the activation may be explicitly carried in dedicated downlink control information or the medium access control element.

The duration of the wake-up period may comprise the duration during which the user equipment is in the DRX active state. During the DRX active state, the user equipment may monitor at least one PDCCH in the local group. The duration of the wake-up period may be predetermined, or may be signalled explicitly in the activation signalling. In some embodiments, the duration of the wake-up period may be configured through higher layer signalling, such as but not limited to, RRC signalling.

The starting time of the wake-up period may provide a time offset for the user equipment to start the wake-up period after receiving the activation signalling. The starting time of the wake-up period may be predetermined, or may be signalled explicitly in the activation signalling. In some embodiments, the starting time of the wake-up period may be configured through higher layer signalling, such as but not limited to, RRC signalling. In some embodiments, the starting time of the wake-up period may be predefined as 0. This may, for example, be the case for an intra-cell group signalling approach.

The cell group flag may be used to indicate to the user equipment to start the wake-up period to monitor the PDCCH in the cell group corresponding to the cell group flag.

Other configurable information may include information such as, but not limited to, parameters of other timers. For example, the other configurable information may comprise an inactivity timer and/or retransmission timer, which may be used to dynamically adjust the DRX configuration of a user equipment.

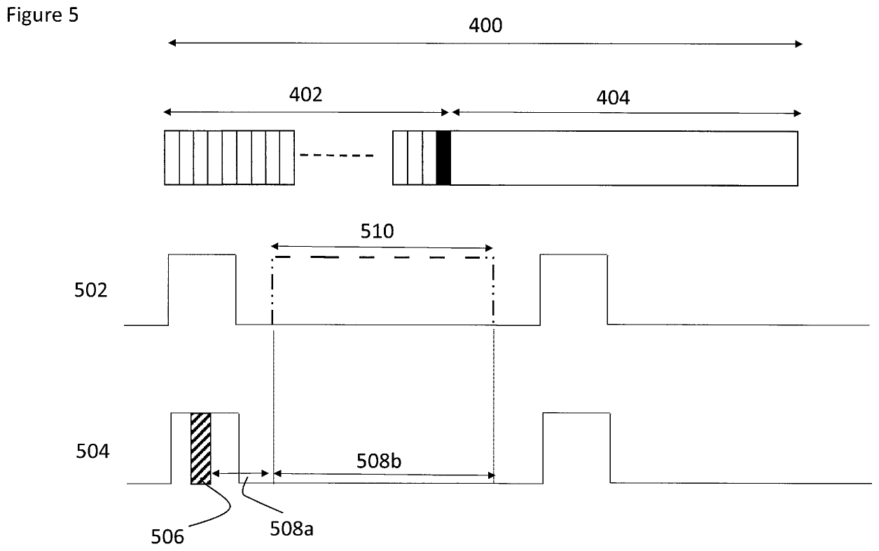

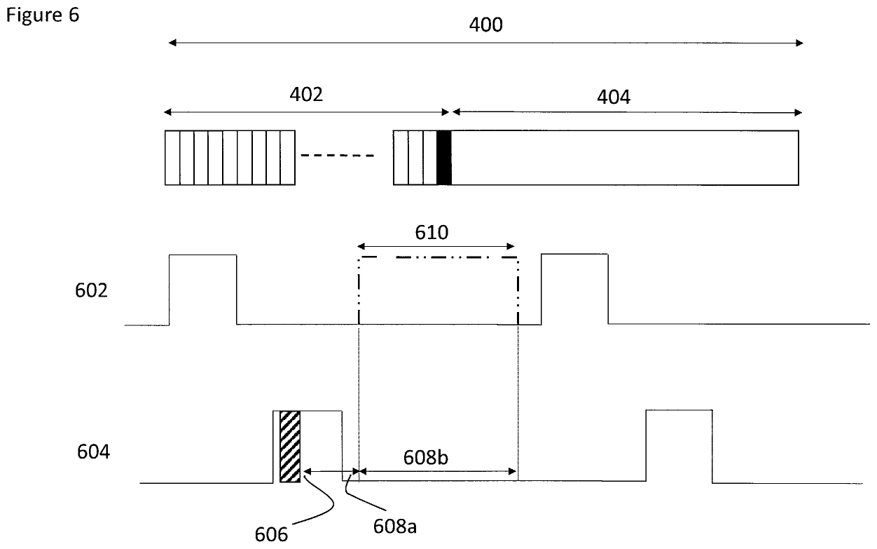

FIGS. 5 and 6 show an altered DRX state of a user equipment according to some embodiments.

In FIG. 5, the DRX state of a user equipment on a first cell is shown in 502 and the DRX state of the user equipment on the second cell is shown in 504. In FIG. 5, the DRX state of the user equipment on the first cell and the second cell are identical. This may, for example, be the case when operating in a carrier aggregation mode, where the user equipment may have a common DRX configuration for all cells in a same cell group.

The user equipment may have to engage in a LBT process on the first cell as described above with reference to FIG. 4. Thus, there is a LBT period 400 associated with the first cell, which is divided up in to a listening period 402 and a talking period 404. As in FIG. 4, the DRX active state of the user equipment may correspond to the listening period 402 on the first cell. As such, the network may have to wait one full DRX cycle before the DRX active state of the user equipment corresponds to the talking period in order to transmit data to the user equipment via the first cell.

The user equipment may therefore receive, from the network via the second cell, activation signalling 506 during a DRX active state of the user equipment. In response, the user equipment may, at a time defined by the starting time of the wake up period 508a, cause the user equipment to enter an additional DRX active state 510 for the first cell. The duration of the DRX active state may be defined by the duration of the wake-up period 508b.

The additional DRX active state 510 may overlap with the talking period 404. Thus, during the additional DRX active state 510, the user equipment may receive data from the network via the first cell.

In FIG. 6, like FIG. 5, the DRX state of a user equipment on a first cell is shown in 602 and the DRX state of the user equipment on the second cell is shown in 604. However in FIG. 6, unlike FIG. 5, the DRX state of the user equipment on the first cell and the second cell are not identical. This may, for example, be the case when operating in a dual connectivity mode, where the user equipment may have a different DRX configuration for each cell group. In some embodiments, the user equipment may comprise two or more receivers. Each receiver may be configured to operate using a different radio technology, on different frequency channels, or the like. The user equipment may have a different DRX configuration for each receiver.

In FIG. 6, the DRX state of the user equipment on a first cell is shown in 602 and the DRX state of the user equipment on the second cell is shown in 604.

As in the previous cases, the user equipment may have to engage in a LBT process on the first cell as described above with reference to FIG. 4. Thus, there is a LBT period 400 associated with the first cell, which is divided up in to a listening period 402 and a talking period 404. As in FIG. 4, the DRX active state of the user equipment may correspond to the listening period 402 on the first cell. As such, the network may have to wait one full DRX cycle before the DRX active state of the user equipment corresponds to the talking period in order to transmit data to the user equipment via the first cell.

The user equipment may therefore receive, from the network via the second cell, activation signalling 606 during a DRX active state of the user equipment on that carrier. In response, the user equipment may, at a time defined by the starting time of the wake up period 608a, cause the user equipment to enter an additional DRX active state 610 for the first cell. The duration of the DRX active state may be defined by the duration of the wake-up period 608b.

In both FIG. 5 and FIG. 6, the second cell may be either a cell configured to operate using a licensed frequency spectrum (a licensed cell) or a cell configured to operate using an unlicensed frequency spectrum (an unlicensed cell). The second cell may not be engaged in a LBT process at the same time as the first cell.

In some embodiments the activation signalling may be transmitted via layer 1 signalling, for example downlink control information. In some embodiments, the activation signalling may be transmitted by higher layer signalling, for example RRC signalling. The transmission method may be dependent on one or more requirements, such as but not limited to network deployment, transmission latency, and reliability.

In some embodiments, a dedicated downlink control information channel may be used to transmit the activation signalling. This may enable fast delivery of the activation signalling. This may be useful for applications with a low latency traffic requirement.

In some embodiments, a dedicated medium access control layer control element may be used to transmit the activation signalling. This may ensure a reliable transmission of the activation signalling. This may reduce the retransmission probability of a scheduled transmission due to a failure in the user equipment detecting the activation signalling.

In some embodiments, the activation signalling may cause the user equipment to operate in an extended DRX mode. In the extended DRX mode, the DRX active period of the user equipment may be extended by a predetermined amount relative to the DRX active period of the normal DRX operation mode of the user equipment. In some embodiments, the user equipment may be configured to deactivate the normal DRX operation mode when the extended DRX operation mode is activated.

When operating in extended DRX mode, the user equipment may return to normal DRX mode based on a deactivation timer. In some embodiments the deactivation timer may be used to deactivate the extended DRX operation mode. The deactivation timer may be started after activation of the extended DRX mode. Additionally or alternatively, the user equipment may return to normal DRX mode in response to receiving a deactivation signal from the network via a cell in the first group and/or the second group. The deactivation signal may be sent via layer 1 signalling, or alternatively may be from higher level signalling, such as but not limited to RRC signalling.

When the activation signalling causes the user equipment to operate in extended DRX mode, the activation signalling may comprise an extended DRX configuration. The extended DRX configuration may comprise a setting of a timer in the DRX configuration, such as but not limited to: onDurationTimer, drx-InacitivityTimer, and drx-RetransmissionTimer.

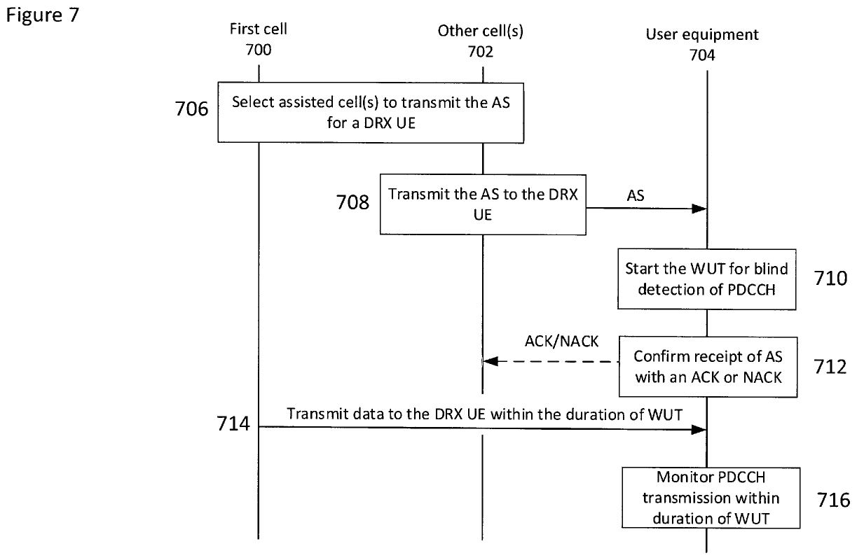

In some embodiments, after receiving a data transmission from the network during the additional active discontinuous reception period or the extended discontinuous reception period, the user equipment may start drx-InactivityTimer or drx-RetransmissionTimer. The starting of the drx-InactivityTimer and/or drx-RetransmissionTimer may depend on a configuration of normal discontinuous reception mode and/or on data decoding results. The starting of the drx-InactivityTimer and/or drx-RetransmissionTimer may depend on a configuration of the extended discontinuous reception mode and/or on data decoding results. Some embodiments shall now be described with reference to FIG. 7.

FIG. 7 shows a signalling exchange according to some embodiments, where the first cell and the one or more other cells are comprised within the same cell group. That is to say, the first cell and the one or more other cells may be controlled by a same network control node. In the signalling exchange of FIG. 7, there is provided a DRX enabled user equipment 704, a first cell 700 and one or more other cells 702.

In step 706, the network may select one or more other cells to transmit the activation signalling to the user equipment. In some embodiments, step 706 may be performed in response to the network determining that one or more trigger conditions described above are satisfied.

In some embodiments, the first cell and/or one or more other cells may operate using an unlicensed frequency spectrum. In some embodiments, the network may selected one or more other cells that operate using a licensed frequency spectrum to transmit the activation signalling. In some embodiments, where the local cell group comprises only unlicensed cells, the network may select a plurality of other cells to transmit the activation signalling.

In step 708, during a DRX active state of the user equipment 704, one of the other cells 702 may transmit the activation signalling to the user equipment 704.

In some embodiments, if a selected one or more other cells operate using a licensed frequency spectrum, the network may configure one of the one or more cells operating on the licensed frequency spectrum to transmit the activation signalling during any time slot of the DRX active state of the user equipment.

In some embodiments, where a plurality of unlicensed cells are selected, a first one of the plurality of selected unlicensed cells that completes a LBT procedure first may be determined to transmit the activation signalling to the user equipment 704.

In step 710, after receiving the activation signalling, the user equipment 704 may start the wake-up period. As described previously, the wake-up period may be started after a time defined by the starting time. After the starting time has expired, the user equipment may enter an additional DRX active state for a duration defined by the wake-up period duration. During the additional DRX active state, the user equipment may monitor the PDCCH in the cell group.

Optionally, at step 712, the user equipment may transmit an ACK or NACK to the one or more other cells from which the activation signalling was received.

In step 714, the first cell 700, after a time defined by the starting time of the wake-up period, and within the duration of the wake-up period, may transmit data to the user equipment 704. In some embodiments, the first cell 704 may only transmit the data to the user equipment 704 if the first cell 700 detects that a channel on which the data is to be transmitted is idle.

In step 716, the user equipment may continue to monitor PDCCH transmission for the duration defined by the wake-up period. In some embodiments, if the user equipment detects a PDCCH within the duration of the wake-up period, the user equipment may start an inactivity or retransmission period. If the user equipment does not detect a PDCCH, the user equipment may enter DRX mode.

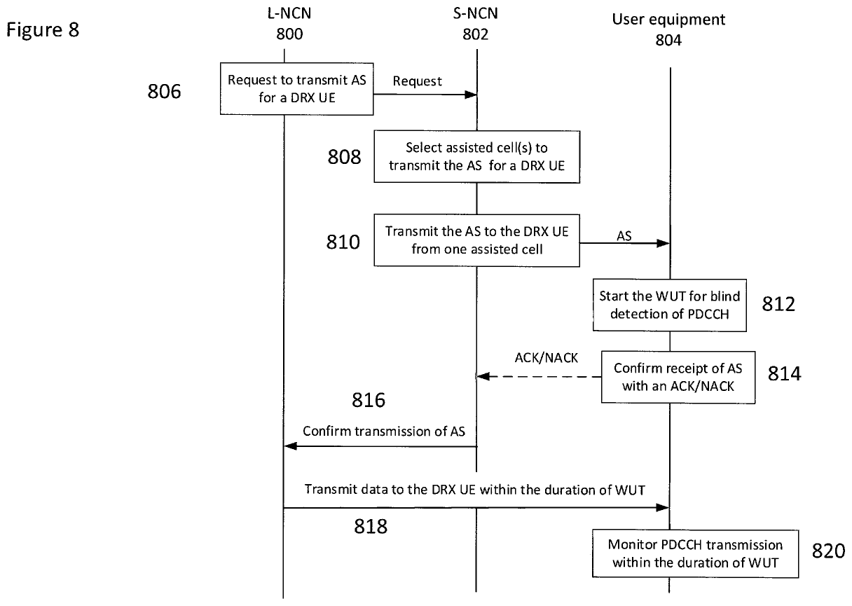

Some embodiments shall now be described with reference to FIG. 8.

FIG. 8 shows a signalling exchange according to some embodiments, where the first cell and the one or more other cells are comprised within different cell groups. This may, for example, be the case where a first frequency channel is provided by a first network node, and one or more other frequency channels are provided by at least a second network node. In the signalling exchange of FIG. 8, there is provided a DRX enabled user equipment 804, a network control node of a first group (L-NCN) 800 and a network control node of a second cell group (S-NCN) 802.

In step 806, the L-NCN may send a request to a S-NCN. The request may comprise a request to transmit activation signalling to the user equipment 804. The request may be sent in response to the network determining that one or more trigger conditions described above have been satisfied.

In some embodiments, the S-NCN may host a service data adaptation protocol (SDAP) entity. The S-NCN may determine how to map the quality of service to one or more digital radio bearers (for example, a master cell group bearer, a secondary cell group bearer, and a split bearer). In some embodiments, the L-NCN may request the S-NCN to transmit the activation signalling to the user equipment in response to the secondary cell group receiving certain quality of service flows which are mapped to the bearer of the local cell group.

In step 808, the S-NCN may select one or more other cells from among the secondary cell group to transmit the activation signalling to the user equipment.

In some embodiments, if a selected one or more other cells are licensed cells, the network may configure one of the one or more licensed cells to transmit the activation signalling during any time slot of the DRX active state of the user equipment.

In some embodiments, where a plurality of unlicensed cells are selected, a first one of the plurality of selected unlicensed cells that completes a LBT procedure first may be determined to transmit the activation signalling to the user equipment 804.

In step 810, during a DRX active state of the user equipment 804, one of the selected one or more other cells 502 may transmit the activation signalling to the user equipment 804.

In step 812, after receiving the activation signalling, the user equipment 804 may start the wake-up period. As described previously, the wake-up period may be started after a time defined by the starting time. After the starting time has expired, the user equipment may enter an additional DRX active state for a duration defined by the wake-up period duration. During the additional DRX active state, the user equipment may monitor the PDCCH in the cell group.

Optionally, at step 814, the user equipment may transmit an ACK or NACK to the one of the selected one or more others cells in the secondary cell group from which the activation signalling was received.

In step 816, after successful transmission of the activation signalling to the user equipment, the S-NCN transmits an acknowledgement to the L-NCN confirming transmission of the activation signalling. The acknowledgement may comprise a transmission time of the activation signalling. Thus, the signalling timing of the L-NCN and the additional DRX active state may be synchronized.

In step 818, the L-NCN 500, after a time defined by the starting time of the wake-up period, and within the duration of the wake-up period, may transmit data to the user equipment 804. In some embodiments, the L-NCN 800 may only transmit the data to the user equipment 804 if the L-NCN 800 detects that a channel on which the data is to be transmitted is idle.

In step 820, the user equipment may continue to monitor PDCCH transmission for the duration defined by the wake-up period. In some embodiments, if the user equipment detects a PDCCH within the duration of the wake-up period, the user equipment may start an inactivity or retransmission period. If the user equipment does not detect a PDCCH, the user equipment may enter DRX mode.

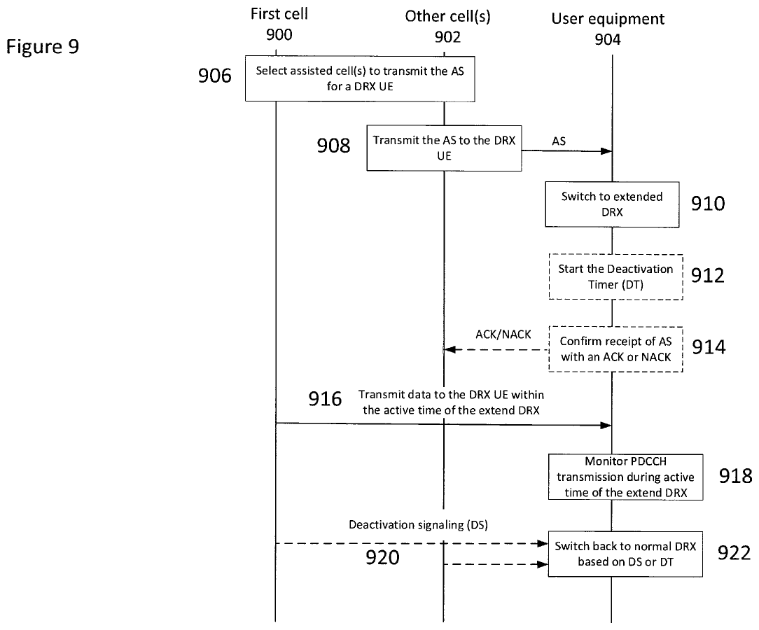

Some embodiments shall now be described with reference to FIG. 9.

FIG. 9 shows a signalling exchange according to some embodiments, where the first cell and the one or more other cells are comprised within the same cell group. In the signalling exchange of FIG. 9, there is provided a DRX enabled user equipment 904, a first cell 900 and one or more other cells 902. The signalling exchange of FIG. 9 may be implemented when the activation signalling causes the user equipment to enter into an extended DRX operation mode.

In step 906, the network may select one or more other cells to transmit the activation signalling to the user equipment. In some embodiments, step 906 may be performed in response to the network determining that one or more trigger conditions described above are satisfied.

In some embodiments, the first cell and/or one or more other cells may comprise an unlicensed cell. In some embodiments, the network may select one or more other cells that are licensed cells to transmit the activation signalling. In some embodiments, where the local cell group comprises only unlicensed cells, the network may select a plurality of other cells to transmit the activation signalling.

In step 908, during a DRX active state of the user equipment 904, one of the other cells 902 may transmit the activation signalling to the user equipment 904.

In some embodiments, if a selected one or more other cells are licensed cells, the network may configure one of the one or more licensed cells to transmit the activation signalling during any time slot of the DRX active state of the user equipment.

In some embodiments, where a plurality of unlicensed cells are selected, a first one of the plurality of selected unlicensed cells that completes a LBT procedure first may be determined to transmit the activation signalling to the user equipment 904.

In step 910, the user equipment may switch from normal DRX mode to extended DRX mode.

Optionally, at step 912, the user equipment may start a deactivation timer. The deactivation timer may be started in response to receiving the activation signalling, or on entry into extended DRX mode.

Optionally, at step 914, the user equipment may transmit an ACK or NACK to the one of the selected one or more others cells in the secondary cell group from which the activation signalling was received.

In step 916, the first cell 900 may transmit data to the user equipment 904. In some embodiments, the first cell 904 may only transmit the data to the user equipment 904 if the first cell 900 detects that a channel on which the data is to be transmitted is idle.

In step 918, the user equipment may continue to monitor PDCCH transmission for the duration that the user equipment is in extended DRX mode.

In step 920, at least one of the first cell and one of the one or more cells may transmit deactivation signalling to the user equipment.

In step 922, on receiving the deactivation signalling, or on expiry of the deactivation timer, the user equipment may switch from extended DRX mode to normal DRX mode.

In some embodiments, there may be provided an apparatus comprising means for performing any of the aforementioned method steps. In some embodiments, the apparatus may comprise at least one memory and at least one processor. The at least one memory may store computer readable instructions which, when executed by the at least one processor, cause the apparatus to perform any of the aforementioned method steps.

In general, the various embodiments may be implemented in hardware or special purpose circuits, software, logic or any combination thereof. Some embodiments may be implemented in hardware, while other aspects may be implemented in firmware or software which may be executed by a controller, microprocessor or other computing device, although the embodiments are not limited thereto. While various aspects may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by a data processor of a device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

An electronic device comprising electronic circuitries may be an apparatus for realizing at least some embodiments of the present invention. The apparatus may be or may be comprised in a computer, a laptop, a tablet computer, a cellular phone, a machine to machine (M2M) device (e.g. an IoT sensor device), a wearable device, a base station, access point device or any other apparatus provided with radio communication capability. In another embodiment, the apparatus carrying out the above-described functionalities is comprised in such a device, e.g. the apparatus may comprise a circuitry, such as a chip, a chipset, a microcontroller, or a combination of such circuitries in any one of the above-described devices.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

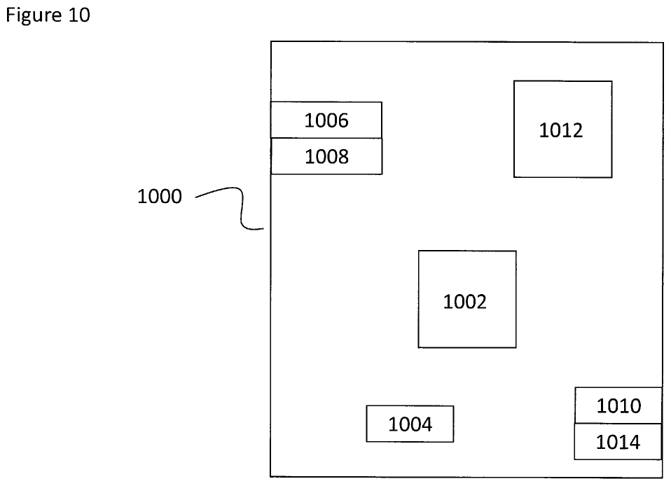

FIG. 10 illustrates an example apparatus capable of supporting at least some embodiments of the present invention. Illustrated is a device 1000, which may comprise a communications device arranged to operate as a access point or the like, for example. The device may include one or more controllers configured to carry out operations in accordance with at least some of the embodiments illustrated above, such as some or more of the blocks illustrated above in connection with FIGS. 4 to 9. The device may be configured to operate as the apparatus configured to carry out any part of the method of any of FIGS. 7 to 9, for example.

Comprised in the device 1000 is a processor 1002, which may comprise, for example, a single- or multi-core processor wherein a single-core processor comprises one processing core and a multi-core processor comprises more than one processing core. The processor 1002 may comprise more than one processor. The processor may comprise at least one application-specific integrated circuit, ASIC. The processor may comprise at least one field-programmable gate array, FPGA. The processor may be means for performing method steps in the device. The processor may be configured, at least in part by computer instructions, to perform actions.

The device 1000 may comprise memory 1004. The memory may comprise random-access memory and/or permanent memory. The memory may comprise at least one RAM chip. The memory may comprise solid-state, magnetic, optical and/or holographic memory, for example. The memory may be at least in part accessible to the processor 1002. The memory may be at least in part comprised in the processor 1002. The memory 1004 may be means for storing information. The memory may comprise computer instructions that the processor is configured to execute. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The memory may be at least in part comprised in the processor. The memory may be at least in part external to the device 1000 but accessible to the device. For example, control parameters affecting operations related to the providing of and/or actions based on the information on beamforming and null steering may be stored in one or more portions of the memory and used to control operation of the apparatus. Further, the memory may comprise device-specific cryptographic information, such as secret and public key of the device 1000.

The device 1000 may comprise a transmitter 1006. The device may comprise a receiver 1008. The transmitter and the receiver may be configured to transmit and receive, respectively, information in accordance with at least one wired or wireless, cellular or non-cellular standard. The transmitter may comprise more than one transmitter. The receiver may comprise more than one receiver. The transmitter and/or receiver may be configured to operate in accordance with global system for mobile communication, GSM, wideband code division multiple access, WCDMA, long term evolution, LTE, 5G or other cellular communications systems, WLAN, and/or Ethernet standards, for example. The device 1000 may comprise a near-field communication, NFC, transceiver 1010. The NFC transceiver may support at least one NFC technology, such as NFC, Bluetooth, Wibree or similar technologies.

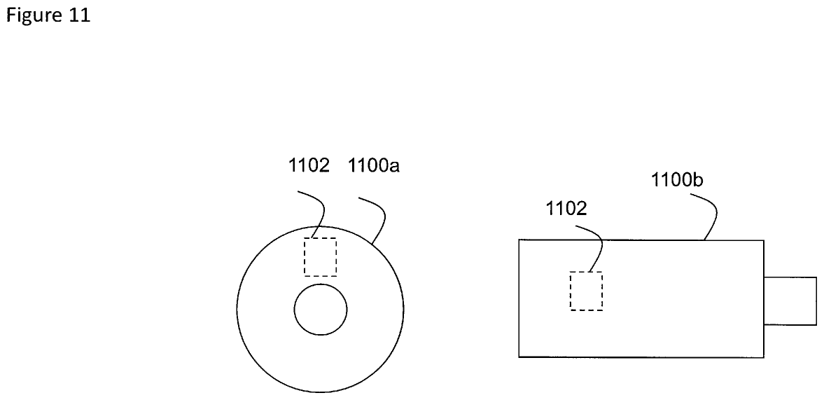

In an embodiment, an apparatus may comprise at least one processor and at least one memory including computer program code. The at least one memory and the computer program code may be configured to, with the at least one processor, cause the apparatus and/or a device to perform one or more of the features of described embodiments. The device may be a user equipment or a network node. FIG. 11 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the method previously described.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Some embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiments. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1.-47. (canceled)

48. A method comprising:
receiving from a second cell at a user equipment in a first state of discontinuous reception mode for a first cell, an indication configured to cause the user equipment to operate in a second state of discontinuous reception mode for the first cell; and
receiving data at the user equipment from the first cell, said data being scheduled based on the indication.

49. The method of claim 48, wherein the indication is received when the user equipment is in a discontinuous reception inactive state for the first cell.

50. The method of claim 48, wherein the first state of discontinuous reception mode for the first cell is different to a discontinuous reception state for the second cell.

51. The method of claim 48, wherein the first cell and the second cell are comprised within different cell groups.

52. The method of claim 48, wherein the indication is configured to cause the user equipment to initiate an additional active discontinuous reception period, wherein the user equipment is able to receive a transmission from the first cell during the additional active discontinuous reception period.

53. The method of claim 48, wherein the indication is configured to cause the user equipment to operate in an extended discontinuous reception mode.

54. The method of claim 53, wherein the extended discontinuous reception period is extended with respect to a discontinuous reception period of a normal discontinuous reception mode.

55. An apparatus comprising at least one memory and at least one processor, the at least one memory storing computer executable instructions which, when performed by the at least one processor, cause the apparatus to:
receive, from a second cell at a user equipment in a first state of discontinuous reception mode for a first cell, an indication configured to cause the user equipment to operate in a second state of discontinuous reception mode for the first cell; and
receive data at the user equipment from the first cell, said data being scheduled based on the indication.

56. The apparatus of claim 55, wherein the indication is received when the user equipment is in a discontinuous reception mode inactive state for the first cell.

57. The apparatus of claim 55, wherein the first state of discontinuous reception mode for the first cell is different to a discontinuous reception state for the second cell.

58. The apparatus of claim 55, wherein the first cell and the second cell are comprised within different cell groups.

59. An apparatus as claimed in claim 55, wherein the second cell is selected from one or more secondary cells.

60. The apparatus of claim 59, wherein the selected second cell comprises a one of the one or more secondary cells that complete a listen-before-talk procedure.

61. The apparatus of claim 55, comprising initiating, by the user equipment, at least one of:
a drx-InactivityTimer; and
a drx-RetransmissionTimer.

62. The apparatus of claim 55, wherein the indication is configured to cause the user equipment to initiate an additional active discontinuous reception period, wherein the user equipment is able to receive a transmission from the first cell during the additional active discontinuous reception period.

63. The apparatus of claim 62, wherein the additional active discontinuous reception period is based, at least in part, on the indication.

64. The apparatus of claim 55, wherein the indication is configured to cause the user equipment to operate in an extended discontinuous reception mode.

65. The apparatus of claim 64, wherein the extended discontinuous reception period is extended with respect to a discontinuous reception period of a normal discontinuous reception mode.

66. The apparatus of claim 64, wherein the apparatus further caused to:
receive, at the user equipment from one of the first cell and the second cell, signaling comprising a configuration of the extended discontinuous reception mode.

67. An apparatus comprising at least one memory and at least one processor, the at least one memory storing computer executable instructions which, when performed by the at least one processor, cause the apparatus to:
select, by a first cell, one or more second cells for transmitting an indication to a user equipment, said user equipment having a first state of discontinuous reception mode for the first cell, said indication configured to cause the user equipment to operate in a second state of discontinuous reception mode for the first cell; and
transmit, by the first cell to the user equipment, data, said data being scheduled based on the indication.
